(19) United States
(12) Patent Application Publication
(10) Pub. No.: US 2011/0006883 A1
(43) Pub. Date: Jan. 13, 2011

(54) METHOD AND SYSTEM FOR MANAGING VIRTUAL SPACE

(75) Inventors: Seung Woon Chang, Seoul (KR); Myung Ryul Choi, Seoul (KR); Jin Chul Kim, Kyungki-do (KR)

Correspondence Address: CHRISTOPHER PAUL MITCHELL, 888 16TH ST., NW, SUITE 800, WASHINGTON, DC, 20006, US

(73) Assignee: Seung Woon CHANG, Seoul (KR)

(21) Appl. No.: 12/920,318

(22) PCT Filed: Feb. 27, 2009
(86) PCT No.: PCT/KR09/00981

§ 371 Date: Aug. 30, 2010

(30) Foreign Application Priority Data
Feb. 29, 2008 (KR) 10-2008-0019197

(51) Int. Cl. G06K 7/01; G06F 15/00

(52) U.S. Cl. 340/10.1; 702/150

(57) ABSTRACT

The present invention sets up a virtual space for an actual work space in which plural goods are loaded and unloaded. The disclosed system may manage the work space by recognizing automatically whether a movable apparatus moving in the virtual space or goods loaded thereon moves into or from the virtual space. Therefore, the work space is efficiently managed

### TECHNICAL FIELD

The present invention relates to a method and a system that can efficiently manage a work space by setting up a virtual space in a work space and automatically managing that a movable apparatus moving in the work space moves into/out of and goods loaded thereon are taken into/out of the virtual space.

### BACKGROUND ART

When a predetermined actual space exists, people can recognize the space from a predetermined dividing line, but- equipment and apparatuses, such as forklifts and transport vehicles, generally use wireless triangulation or fixed work paths in order to recognize the space.

However, the triangulation has a problem in that the cost increases in geometric progressions in proportion to the accuracy and the fixed work paths have a problem in that it is difficult to deal with works under an environment with a lot of works at one time. In particular, a plan that can more efficiently manage a work space where a plurality of goods is taken in/out has been required.

### DISCLOSURE

### Technical Problem

Accordingly, it is an object of the present invention to provide a method and a system that can efficiently manage a work space by setting up a virtual space in a work space and automatically managing that a movable apparatus moving in the work space moves into/out of and goods loaded thereon are taken into/out of the virtual space.

### Technical Solution

A method of managing a virtual space according to an aspect of the present invention sets a virtual line dividing a virtual work space region in an actual work space where goods are taken in/out, for taking-in/out of the goods, on the floor of the work space, embeds one or more recognizing sensors at predetermined intervals at both sides of the virtual line, and provides a movable apparatus that moves into/out of the work space with one or more sensor recognition readers that read the recognizing sensors, in which the method may include: consistently storing first sensor information in the recognizing sensors embedded inside the virtual work space from the virtual line and second sensor information in the recognizing sensors embedded in the outside of the virtual work space, in order to recognize whether the movable apparatus passes the virtual line; and determining that the movable apparatus does not move out from the virtual work space, when the sensor recognition reader reads first sensor information and then reads the same kind of first sensor information, and determining that the movable apparatus has moved out from the virtual work space, when the sensor recognition reader reads first sensor information and then reads a different kind of second sensor information. The method may further include: ascertaining whether on or more goods are loaded on the movable apparatus, when determining that the movable apparatus has moved out from the virtual work space in the determining; and when ascertaining that one or more goods are loaded on the movable apparatus, deciding that the ascertained goods have been taken out from the virtual work space. Further, the method may further include: determining that the movable apparatus does not move in the virtual work space, when the sensor recognition reader reads second sensor information and then reads the same kind of sensor information, and determining that the movable apparatus has moved in the virtual work space, when the sensor recognition reader reads second sensor information and then reads a different kind of first sensor information. Further, the method may further include: ascertaining whether one or more goods are loaded on the movable apparatus, when determining that the movable apparatus has moved in the virtual work space in the determining; and when ascertaining that one or more goods are loaded on the movable apparatus, deciding that the ascertained goods have been taken in the virtual work space. Further, in the method, when the first sensor information includes odd-numbered information, the second sensor information may include even-numbered information, or when the first sensor information includes even-numbered information, the second sensor information may include odd-numbered information, or when the first sensor information includes information outputted at ‘0’ by bit calculation with the information included in the sensor recognition reader, the second sensor information may include ‘1’ or information outputted as ‘1’ by bit calculation with the information included in the sensor recognition reader, or when the first sensor information includes ‘1’ or information outputted as ‘1’ by bit calculation with the information included in the sensor recognition reader, the second sensor information may include ‘0’ or information outputted as ‘0’ by bit calculation with the information included in the sensor recognition reader, or when the first sensor information includes ‘TRUE’ or information recognized as ‘TRUE’, the second sensor information may include ‘FALSE’ or information recognized as ‘FALSE’, or when the first sensor information includes ‘FALSE’ or information recognized as ‘FALSE’, the second information sensor may include ‘TRUE’ or information recognized as ‘TRUE’.

Further, a recording medium according to another aspect of the present invention is recorded with a program executing the method according to any one of claims 1 to 5, and can be read by a computer.

Further, a movable apparatus according to another aspect of the present invention moves into/out of a space in which a virtual line dividing a virtual work space region in an actual work space where goods are taken in/out, for taking-in/out of the goods, on the floor of the work space, one or more recognizing sensors are embedded at predetermined intervals at both sides of the virtual line, first sensor information is stored in one or more recognizing sensors embedded inside the virtual work space and second sensor information is stored in one or more recognizing sensors embedded outside the virtual work space, in which the movable apparatus may include: a sensor recognition reader that sequentially reads one or more recognition sensor informations from the recognizing sensors; an RFID reader that reads one or more RFID informations from RFID tags attached the goods; and a communication module that transmits at least one of the recognition sensor informations, taking-in information of the goods and taking-out information of the goods which are ascertained by reading the recognition sensor information, and the RFID code information, to a server, by using a communication network. The movable apparatus may further include: a processing module that determines that the movable apparatus does not move out from the virtual work space, when first sensor information of the recognition sensor informations is read and then the same kind of first sensor information is sequentially read from the recognizing sensors, and determines that the movable apparatus has moved out from the virtual work space, when first sensor information of the recognition sensor informations is read and then a different kind of second sensor information is sequentially read from the recognition sensor. Further, the processing module may ascertain the one or more RFID code informations and decide that the goods corresponding to the ascertained RFID code informations have been taken out from the virtual work space, when it is determined that the movable apparatus has moved out from the virtual work space. Further, the processing module may determine that the movable apparatus does not move in the virtual work space, when second sensor information of the recognition sensor informations is read and then the same kind of second sensor information is sequentially read from the recognizing sensors, and may determine that the movable apparatus has moved in the virtual work space, when second sensor information of the recognition sensor informations is read and then a different kind of first sensor information is sequentially read from the recognizing sensors. Further, the processing module may ascertain the one or more RFID code informations and may decide that the goods corresponding to the ascertained RFID code informations have been taken in the virtual work space, when it is determined that the movable apparatus has moved in the virtual work space. Further, the sensor recognition reader may include one or more directional antennas facing the floor of the work space.

Further, a system for managing a virtual work space according to another aspect of the present invention sets a virtual line dividing a virtual work space region in an actual work space where goods are taken in/out, for taking-in/out of the goods, on the floor of the work space, embeds one or more recognizing sensors at predetermined intervals at both sides of the virtual line, and constantly stores first sensor information in one or more recognizing sensors embedded inside the virtual work space and second sensor information in one or more recognizing sensors embedded outside the virtual work space such that a movable apparatus moving into/out of the work space reads one or more recognition sensor information from the recognizing sensors, in which the system may include: an information receiving unit that sequentially receives one or more recognition sensor informations that are received from the movable apparatus; a moving-out ascertaining unit that determines that the movable apparatus does not move out from the virtual work space, when first sensor information of the recognition sensor informations is received and then the same kind of first sensor information is sequentially received, and determines that the movable apparatus has moved out from the virtual work space, when first sensor information of the recognition sensor informations is received and then a different kind of second sensor information is sequentially received; and a moving-in ascertaining unit that determines that the movable apparatus has moved in the virtual work space, when second sensor information of the recognition sensor informations is received and the same kind of second sensor information is received, and determines that the movable apparatus has moved in the virtual work space, when second sensor information of the recognition sensor informations is received and then first sensor information is sequentially received.

### Advantageous Effects

According to the present invention, it is possible to efficiently manage a work space by setting up a virtual space in an actual work space where a plurality of goods is taken in/out and automatically recognizing and managing that a movable apparatus moving in the work space moves into/out of the virtual space or that goods loaded on the movable apparatus are taken into/out of the virtual space.

### DESCRIPTION OF DRAWINGS

FIG. 1 is a diagram illustrating operating principle of a system for managing a virtual space of the present invention;

FIG. 2 is a diagram schematically illustrating the structure of a system for managing a virtual space according to an implementing example of the present invention;

FIG. 3 is a diagram schematically illustrating the structure when a recognizing sensor and the sensor recognition reader are an RFID sensor and an RFID reader, respectively, in the system for managing a virtual space shown in FIG. 2, according to an implementing example of the present invention;

FIG. 4 is a flowchart illustrating a method of reading information for managing a virtual space according to an implementing example of the present invention, in a method of managing a virtual space of the present invention;

FIG. 5 is a flowchart illustrating a method of reading information for managing a virtual space according to another implementing example of the present invention, in the method of managing a virtual space of the present invention; and

FIG. 6 is a flowchart illustrating a method of managing a virtual space according to another implementing example of the present invention, in the method of managing a virtual space of the present invention.

### BEST MODE

Implementing examples of the present invention are described herein in detail with reference to the accompanying drawings. The terminologies described hereafter are defined to effectively explain various functions of the present invention and may be changed by those skilled in the art, in which the definition of the terminologies should be made on the basis of the spirit of the present invention.

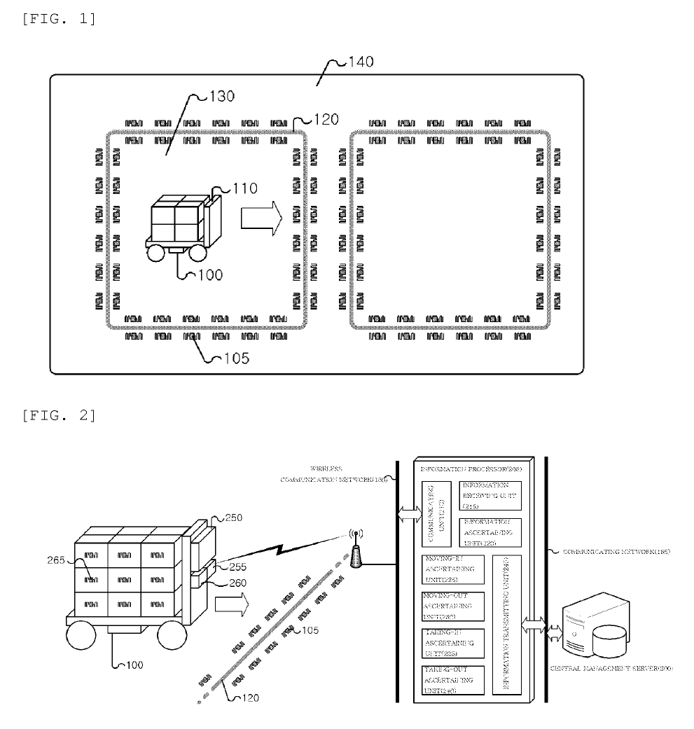

First, FIG. 1 is a diagram illustrating operating principle of a system for managing a virtual space of the present invention.

Referring to FIG. 1, in the system for managing a virtual space, one or more virtual work spaces 130 are separately set first in accordance with taking-in/out of a plurality of goods by a closed virtual line 120 on the floor of an actual work space 140 for taking-in/out of the goods in order to manage the virtual space, and a plurality of pairs of recognizing sensors 105 may be embedded (or attached) at regular intervals at both sides of the virtual line 120. Further, the same kind of first sensor information and the same kind of second sensor information may be consistently stored respectively in the one or more recognizing sensors 105 embedded (or attached) inside the virtual work space 130 with respect to the virtual line 120, and one or more recognizing sensors 105 making pairs with the above recognizing sensors 105 and embedded (attached) outside the virtual work space 130. Further, a movable apparatus 110 (e.g. a forklift or a transport vehicle) moving in the virtual work space may be equipped with a sensor recognition reader 100, which can sense the recognizing sensors 105, at the bottom.

Therefore, it is possible to automatically determine whether the movable apparatus 110 moves into/out of (or goods loaded on the movable apparatus are taken into/out of) the virtual work space 130, by reading two or more recognizing sensor informations sequentially read by the sensor recognition reader 100 to ascertain whether the movable apparatus 110 passes the virtual line 120, as the movable apparatus 110 accesses the virtual work space 130. In this case, in the access described above, the same kind of first sensor information may be read, after the first sensor information is read from the recognizing sensor 105 at both sides of the virtual line 120 by the sensor recognition reader 100 of the movable apparatus 110, or a different kind of second sensor information may be read, after the first sensor information is read, or the same kind of second sensor information may be read, after the above second sensor information is read, or a different kind of sensor information may be read, after the above second sensor information is read. That is, as an example, when the sensor recognition reader 100 of the movable apparatus 110 reads the first sensor information from the recognizing sensor 105 and then reads the same kind of first sensor information, it is determined that the movable apparatus 110 moves within the virtual work space 130, and when goods are loaded on the movable apparatus 110, it is determined that the goods are not yet taken out of the virtual work space 130. As another example, when the sensor recognition reader 100 of the movable apparatus 110 reads the first sensor information from the recognizing sensor 105 and then reads a different kind of second sensor information, it is determined that the movable apparatus 110 has moved out of the virtual work space 130 and moves at the outside, and when goods are loaded on the movable apparatus 110, it is determined that the goods have been taken out of the virtual work space 130. As another example, when the sensor recognition reader 100 of the movable apparatus 110 reads the second sensor information from the recognizing sensor 105 and then reads the same kind of second sensor information, it is determined that the movable apparatus 110 does not yet move into the virtual work space 130, moving at the outside, and when goods are loaded on the movable apparatus 110, it is determined that the goods are not yet taken in the virtual work space 130. As another example, when the sensor recognition reader 100 of the movable apparatus 110 reads the second sensor information from the recognizing sensor 105 and then reads a different kind of first sensor information, it is determined that the movable apparatus 110 have moved into the virtual work space 130 from the outside and moves therein, and when goods are loaded on the movable apparatus 110, it is determined that the goods have been taken in the virtual work space 130.

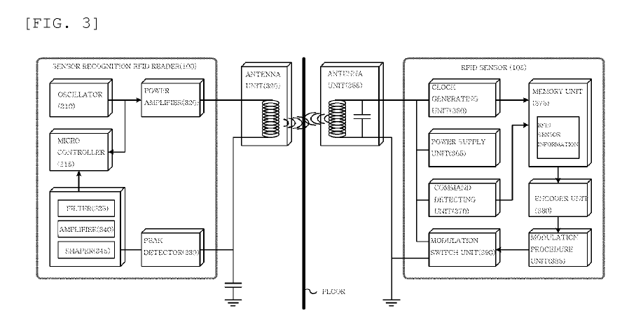

FIG. 2 is a diagram schematically illustrating the structure of a system for managing a virtual space according to an implementing example of the present invention.

Referring to FIG. 2, a system for managing a virtual space 10 according to this implementing example may include: a movable apparatus 110; an information processor 205 that determines that the movable apparatus 110 moves into/out of a virtual work space 130 (or at least one or more goods loaded on the movable apparatus 10 are taken into/out of the virtual work space 130) by reading information from the movable apparatus 110, and a central management server 200 that manage that goods are taken into/out of the virtual work space 130 in link with the information processor 205.

In this implementing example, the movable apparatus 110 may include: a plurality of pairs of recognizing sensors 105 that are embedded (or attached) at regular intervals at both sides of a virtual line 120 dividing one or more virtual work spaces (130 in FIG. 1) set in an actual work space (140 in FIG. 1); a sensor recognition reader 100 that is disposed at a position suitable for reading of the recognizing sensors 105 on the bottom of the movable apparatus 110 and reads one or more recognition sensor informations from the recognizing sensors 105; an RFID reader 250 that reads one or more RFID code informations (e.g. EPC code or ISO code) from RFID tags 265 attached to one or more goods loaded on the movable apparatus 110; and a communication module 255 that transmits the information read by the sensor recognition reader 100 and the RFID reader 250, using a wireless communication network or a wireless local area network 160.

The recognizing sensors 105 are RFID tags (or devices) and the recognizing sensors 105 embedded (or attached) inside the virtual work space (130 in FIG. 1) with respect to the virtual line 120 store consistently the same kind of first sensor information and the others embedded (or attached) outside the virtual work space consistently store the same kind of second sensor information making a pair with the first sensor information. In this case, in an embodiment, when the first sensor information includes odd-numbered information, the second sensor information may include even-numbered information, or vice versa. In another embodiment, when the first sensor information includes ‘0’ (or information outputted as ‘0’ from bit calculation with the information in the sensor recognition reader 100), the second sensor information may include ‘1’ (or information outputted as ‘1’ from bit calculation with the information in the sensor recognition reader 100), or vice versa. In another embodiment, when the first sensor information includes ‘TRUE (or information recognized as ‘TRUE’), the second sensor information may include ‘FALSE’ (or information recognized as ‘FALSE’), or vice versa.

Further, the recognizing sensor 105 performs wireless communication in accordance with any one wireless interface in ISO 18000 series of wireless interface and may be include an RFID sensor having sensor information (i.e., RFID code) according to the RFID code system. As another embodiment, the recognizing sensor 105 may include a wireless sensor that wirelessly sends out a hoping signal or a wireless frequency signal which includes the sensor information. As another embodiment, the recognizing sensor 105 may include an optical sensor including one or more of a barcode shown by encoding sensor information in accordance with predetermined encoding, a 2D barcode, and a color code. As another embodiment, the recognizing sensor 105 may include a magnetic sensor including one or more of a magnetic stripe recorded by magnetizing sensor information and a magnetic field generator.

Further, it is preferable that the recognizing sensors 105 are embedded (or attached) at regular intervals on the floor of the work space in order not to be influenced by transmission/reception of wireless frequency signals.

The sensor recognition reader 100 can periodically read one or more of first and second sensor informations from one or more of the recognizing sensors 105 embedded (attached) in the floor of the work space. As an embodiment, when the recognizing sensor 105 includes the RFID sensor, the sensor recognition reader 100 may include an RFID reader that reads sensor information from the wireless recognizing sensor in accordance with any one wireless interface in ISO 18000 series of wireless interface. As another embodiment, when the recognizing sensor 105 includes a wireless sensor, the sensor recognition reader 100 may include a wireless receiver that receives wireless frequency signals sent out from the wireless sensor. As another embodiment, when the recognizing sensor 105 includes an optical sensor, the sensor recognition reader 100 may include one or more of a barcode reader, a 2D barcode reader, and a color code reader which optically scan and recognize an optical sensor. As another embodiment, when the recognizing sensor 105 includes a magnetic sensor, the sensor recognition reader 100 may be a magnetic recognition device that reads the magnetic stripe in contact with the bottom of the sensor recognition reader 100, or may include one or more magnetic field readers that recognize a magnetic field generated from the magnetic field generator.

Further, it is preferable that the sensor recognition reader 100 include one or more directional antennas facing the floor of the work space to periodically read one or more of first and second sensor informations from the recognizing sensor 105 embedded (attached) in the floor of the work space, without recognizing RFID code information from the RFID tags 265 attached to the goods loaded on the movable apparatus. Further, it is preferable that a wireless frequency shield (e.g. a net coated with a conductive material) is disposed between the sensor recognition reader 100 and the good-loading space of the movable apparatus 110 such that the wireless frequency signals sent out from the sensor recognition reader 100 fail to reach the good-loading space.

When the sensor recognition reader 100 sequentially reads first and second sensor information, the communication module 255 can transit recognition sensor information sequentially including the read first and second sensor information to the information processor 205, using the wireless communication network (or a wireless local area network). Further, when the RFID reader 250 reads one or more RFID code informations, the communication module 255 can transmit the read one or more RFID code informations to the information processor 205, using the wireless communication network (or a wireless local area network).

Further, in this implementing example, as described above, the information processor 205 can determine that the movable apparatus 10 moves into/out of (or one or more goods loaded on the movable apparatus 110 are taken into/out of the virtual work space 130) the virtual work space 130 by recognizing whether the movable apparatus 110 has passed the virtual line 120 on the basis of the information received and read by the communication module 255 from the sensor recognition reader 100 and the RFID reader 250. Further, although the information processor 205 is shown in FIG. 2 as an external device having a communication channel connected with the communication module 255 of the movable apparatus 110 by the wireless communication network (or the wireless local area network 160), the present invention is not limited thereto, and the information processor 205 may be implemented by a processing module 260 provided in the movable apparatus 110 or may be disposed in the central management server 200 that manages taking-in/out.

Referring to FIG. 2, the information processor 205 may include a communicating unit 210, an information receiving unit 215, an information ascertaining unit 220, an moving-in ascertaining unit 225, a moving-out ascertaining unit 230, a taking-in ascertaining unit 235, a taking-out ascertaining unit 240, and an information transmitting unit 245.

The communicating unit 210 connects communication module 255 of the movable apparatus 110 with a wireless communication channel (or a wireless local area network channel), which transmits/receives recognition sensor information read from the sensor recognition reader 100 or one or more RFID code informations read from the RFID reader 250, and manages them, by using a protocol (e.g. IEEE802.11a/b/g/n/p, IEEE802.16, and IEEE802.15), which corresponds to the wireless communication network (or the wireless local area network).

Further, the information receiving unit 215 integrally receives one or more of recognition sensor informations read by the sensor recognition reader 100 from the communication module 255 of the movable apparatus 110 and RFID code information read by the RFID reader 250, in link with the communicating unit 210.

Further, the information ascertaining unit 220 ascertains whether the sensor recognition reader 100 of the movable apparatus 110 has sequentially read the same kind of recognition sensor information (e.g., reading first sensor information and then reading the same kind of first sensor information), or has sequentially read different kinds of recognition sensor information (e.g., reading first sensor information and then reading a different kind of second sensor information, or reading second sensor information and then reading a different kind of first sensor information), by reading the received recognition sensor information.

Further, the moving-in ascertaining unit 225 determines whether the movable apparatus 110 has moved in the virtual work space 130, on the basis of the result ascertained by the information ascertaining unit 220. As an example, when it is ascertained by the information ascertaining unit 220 that the sensor recognition reader 100 of the movable apparatus 110 has read the second sensor information from the recognizing sensor 105 and the read the same kind of second sensor information, it is ascertained by the moving-in ascertaining unit 225 that the movable apparatus 110 has not moved in the virtual work space 130 and exists at the outside. As another example, when it is ascertained by the information ascertaining unit 220 that the sensor recognition reader 100 of the movable apparatus 110 has read the second sensor information from the recognizing sensor 105 and then read a different kind of first sensor information, it is ascertained by the moving-in ascertaining unit 225 that the movable apparatus 110 has moved in the virtual work space 130 from the outside.

Further, the moving-out ascertaining unit 230 determines whether the movable apparatus 110 has moved out of the virtual work space 130 on the basis of the result ascertained by the information ascertaining unit 220. As an example, when it is ascertained by the information ascertaining unit 220 that the sensor recognition reader 100 of the movable apparatus 110 has read the first sensor information from the recognizing sensor 105 and then read the same kind of first sensor information, it is ascertained by the moving-out ascertaining unit 230 that the movable apparatus 110 does not move out of the work space 130 and moves therein. As another example, when it is ascertained that the sensor recognition reader 100 of the movable apparatus 110 has read the first sensor information from the recognizing sensor 105 and then read a different kind of second sensor information, it is ascertained by the moving-out ascertaining unit 230 that the movable apparatus 110 has moved outside from the virtual work space 130.

Further, when it is ascertained by the moving-in ascertaining unit 225 that the movable apparatus 110 has moved in the virtual work space 130, the taking-in ascertaining unit 235 ascertains RFID code information read by the RFID reader 250 of the movable apparatus 110 through the information receiving unit 215 (or whether RFID code information has been read), and if it is ascertained, it is ascertained that the goods loaded on the movable apparatus 110 has been taken in the virtual work space 130.

Further, when it is ascertained by the moving-out ascertaining unit 230 that the movable apparatus 110 has moved out of the virtual work space 130, the taking-out ascertaining unit 240 ascertains RFID code information read by the RFID reader 250 of the movable apparatus 110 through the information receiving unit 215 (whether RFID code information has been read), and if it is ascertained, it is ascertained that the goods loaded on the movable apparatus 110 has been taken out of the virtual work space 130.

Further, when moving-in/out of the movable apparatus 110 and/or the goods is ascertained by the moving-in ascertaining unit 225, the moving-out ascertaining unit 230, the taking-in ascertaining unit 235, and the taking-out ascertaining unit 240, the information transmitting unit 245 transmits moving-in or moving out ascertainment information of the movable apparatus 110 and/or taking-in or taking-out ascertainment information of the goods to the central management server 200, by using the communication network 165. In this process, it is preferable that the moving-in or moving-out ascertainment information of the movable apparatus 110 includes at least one or more of identification information of the movable apparatus (e.g. RFID tag information given to the movable apparatus), pallet identification information (e.g. RFID tag information given to the pallet with the goods thereon), and virtual work space information (e.g. ID information of the virtual work space). Further, it is preferable that the taking-in or taking-out ascertainment information of the goods includes at least one or more of the identification informations of the movable apparatus, the pallet identification information, the virtual work space information, which are described above, and at least one of RFID code information loaded on the movable apparatus.

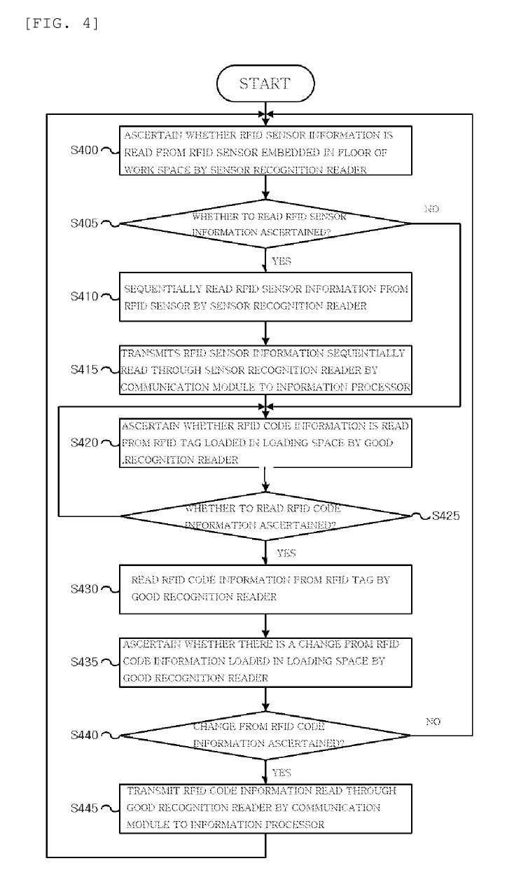

FIG. 3 is a diagram schematically illustrating the structure when the recognizing sensor 105 and the sensor recognition reader 100 are particularly an RFID sensor and an RFID reader, respectively, in the system for managing a virtual space shown in FIG. 2, according to an implementing example of the present invention. Other various embodiments of the recognizing sensor 105 and the sensor recognition reader 100 were described in detail in the above.

The recognizing sensor 105 usually includes an RF chip and an antenna circuit, in which the RF chip may be implemented in various ways, including RF chips equipped with predetermined logic device and memory device and IC chips for non-contact type IC cards, in accordance with the intention of those skilled in the art and frequency ranges (or the types of frequency modulation). IN particular, FIG. 3 illustrates a predetermined MCU (MicroController Unit) for implementing the function of the recognizing sensor 105 and the present invention is not limited thereto.

Referring to FIG. 3, the recognizing sensor 105 may include an antenna unit 355 that transmits/receives wireless frequency signals at a predetermined frequency band from the sensor recognition reader 100, a memory unit 375 that stores predetermined recognition information, a clock generating unit 360, a power supply unit 365, and a command detecting unit 370, an encoder unit 380, a modulation procedure unit 385, and a modulation switch unit 390.

Further, the memory unit 375 stores recognition sensor information including a predetermined code value including one or more of an EPC (Electronic Product Code), a U-code, and ISO/IEC 15963, in accordance with the memory structure. Further, the memory unit 375 may include one or more of a ROM (Read Only Memory), a read/write memory (e.g. EEPROM (Electrically Erasable and Programmable Read Only Memory), an FM (Flash Memory), a RAM (Random Access Memory), and a WORM (Write Once Read Many) memory.

Further, the power supply unit 365 generates predetermined power having predetermined voltage from a wireless frequency signal received by the antenna unit 355, for a passive recognizing sensor 105, or stores predetermined power for an active recognizing sensor 105, and the power is supplied to the whole recognizing sensors 105.

Further, the clock generating unit 360 generates a predetermined clock on the basis of a wireless frequency signal inputted from the antennal unit 355 and the command detecting unit 370 detects a predetermined command from the wireless frequency signal inputted from the antenna unit 355, in which predetermined recognition information is extracted from the memory unit 375 by the clock and the command and then supplied to the encoder unit 380. Further, the recognition sensor information encoded by the encoder unit 380 is modulated by the modulation switch unit 390 on the basis of a predetermined modulation procedure of the modulation procedure unit 385 and then transmitted to the sensor recognition reader 100 through the antenna unit 355.

Further, the sensor recognition unit 100 generally includes an electronic circuit sending out or receiving radio waves at a predetermined frequency to/from the recognizing sensor 105 and an antenna linked with the electronic circuit, and a microcontroller 315 extracting and checking predetermined data by reading a signal received from the recognizing sensor 105.

Referring to FIG. 3, the sensor recognition reader 100 includes: an oscillator 310 that controls a wireless frequency signal to send out through the antenna unit 325 (e.g. a directional antenna), the microcontroller 315 that controls sending-out of the wireless frequency signal through the antenna unit 325, a power amplifier 320 that amplifies power to send out the wireless frequency signal through the antenna unit; and a peak detector 330 that detects a peak of the wireless frequency signal received by the recognizing sensor 105 through the antenna unit 325, and may further include a shaper 345 that shapes the detected peak and/or an amplifier 340 that amplifies the peak and/or a filter 335 that filters the peak. In particular, it is preferable that the microcontroller 315 further has a function of reading out predetermined data from the peak (e.g. shaped and/or amplified and/or filtered peak) and reading the data. According to this embodiment, transmitting/receiving a wireless frequency signal between the sensor recognition reader 100 and the recognizing sensor 105 can be performed by modulation including at least one or more of common modulations including ASK (Amplitude Shift Keying), FSK (Frequency Shift Keying), and PSK (Phase Shift Keying).

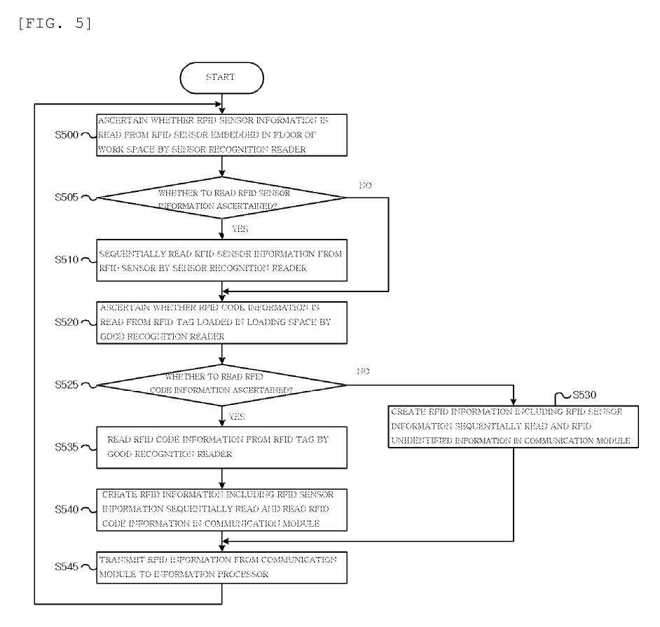

FIG. 4 is a flowchart illustrating a method of reading information for managing a virtual space according to an implementing example of the present invention, in a method of managing a virtual space of the present invention.

Referring to FIG. 4, the sensor recognition reader 100 of the movable apparatus 110 ascertains whether one or more recognition sensor informations are read by one or more of the pairs of recognizing sensors 105 embedded (or attached) at both sides of the virtual line on the floor of the work space (S400).

When it is ascertained that the recognizing sensor 105 reads one or more recognition sensor informations (S405), the sensor recognition reader 100 sequentially reads one or more recognition sensor informations from one or more of the recognizing sensors 105 (S410). In this process, it is general that the sensor recognition reader 100 simultaneously reads one or more recognition sensor informations from the recognition sensors 105 existing within a reaching range of a wireless frequency of a unit time. In particular, it is preferable that the sensor recognition reader 100 decides that the same kind of recognition sensor information is first received, when the same kind of recognition sensor information is simultaneously read for a unit time, and decides that a different kind of information, which is different from the recognition sensor information read for the previous unit time was sequentially read, when the same kind of recognition sensor information and a different kind of information are simultaneously read for the next unit time.

Thereafter, the communication module 255 of the movable apparatus 110 transmits one or more recognition sensor informations sequentially read by the sensor recognition reader 100 to the information processor 205, by using the wireless communication network (or wireless local area network) (S415).

Further, the RFID reader 250 of the movable apparatus 110 ascertains whether one or more RFID code informations are read from one or more of the RFID tags 265 attached to the goods loaded on the loading space of the movable apparatus 110 (S420).

When it is ascertained that one or more RFID code informations are read from the RFID tags 265 (S425), the RFID reader 250 reads one or more RFID code informations from the RFID tags 265 (S430) and ascertains whether there is a change between the read RFID code informations and the RFID code informations read for the previous unit time (S435). That is, when the RFID code informations read from the RFID tags 265 have changed, as compared with the RFID code informations read for the previous unit time, it means that new goods were loaded in the loading space of the movable apparatus 110 or the goods loaded on the loading space were unloaded.

When there is a change between the read RFID code informations and the RFID code informations read for the previous unit time (S440), the communication module 255 transmits one or more RFID code informations read by the RFID reader 250 to the information processor 205, by using the wireless communication network (or the wireless local area network) (S445).

FIG. 5 is a flowchart illustrating a method of reading information for managing a virtual space according to another implementing example of the present invention, in the method of managing a virtual space of the present invention.

Referring to FIG. 5, the sensor recognition reader 100 of the movable apparatus 110 ascertains whether one or more recognition sensor informations are read by one or more of the pairs of recognizing sensors 105 embedded (or attached) at both sides of the virtual line on the floor of the work space (S500).

When it is ascertained that the recognizing sensor 105 reads one or more recognition sensor informations (S505), the sensor recognition reader 100 sequentially reads one or more recognition sensor informations from one or more of the recognizing sensors 105 (S510). In this process, as described with reference to FIG. 4, the sensor recognition reader 100 simultaneously reads one or more recognition sensor informations from the recognition sensors 105 existing within a reaching range of a wireless frequency of a unit time. Further, it is preferable that the sensor recognition reader 100 decides that the same kind of recognition sensor information is first received, when the same kind of recognition sensor information is simultaneously read for a unit time, and decides that a different kind of information, which is different from the recognition sensor information read for the previous unit time was sequentially read, when the same kind of recognition sensor information and a different kind of information are simultaneously read for the next unit time.

Further, the RFID reader 250 of the movable apparatus 110 ascertains whether one or more RFID code informations are read from one or more of the RFID tags 265 attached to the goods loaded on the loading space of the movable apparatus 110 (S520).

Further, when it is not ascertained that one or more RFID code informations are read from the RFID tags 265 (S525), the communication module 255 creates information including recognition sensor informations sequentially read by the sensor recognition reader 100 and RFID code unidentified information (S530), and then transmits the created information to the information processor 205, by using the wireless communication network (or the wireless local area network) (S545).

On the contrary, when it is ascertained that one or more RFID code informations are read from the RFID tags 265 (S525), the RFID reader 250 reads one or more RFID code informations from one or more RFID tags 265 (S535), creates information including the recognition sensor informations sequentially read by the sensor recognition reader 100 and one or more RFID code information read by the RFID reader 250 (S540), and then transmits the created information to the information processor 205, by using the wireless communication network (or the wireless local area network) (S545).

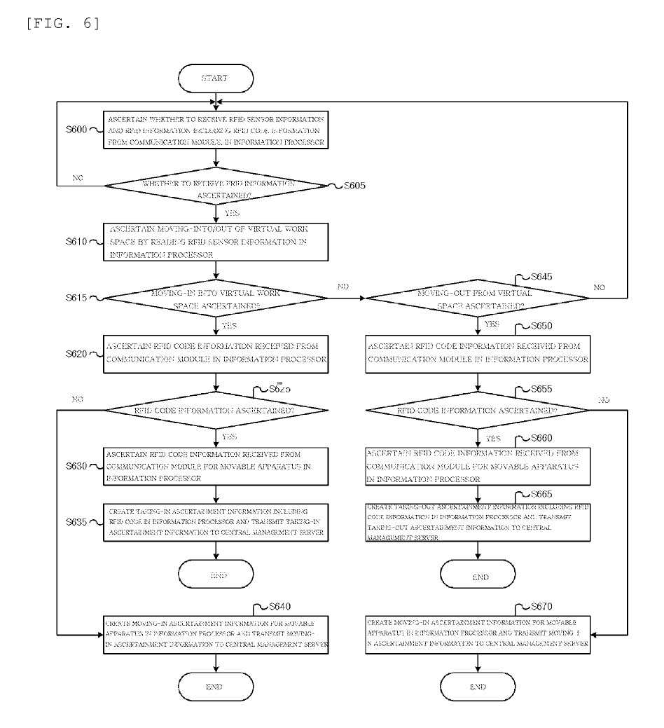

FIG. 6 is a flowchart illustrating a method of managing a virtual space according to another implementing example of the present invention, in the method of managing a virtual space of the present invention.

Referring to FIG. 6, the information processor 205 ascertains whether information including one or more of recognition sensor information and RFID code information is received from the communication module 255 of the movable apparatus 110, through the process of the implementing example illustrated in FIG. 4 or the implementing example illustrated in FIG. 5 (S600).

Further, when it is ascertained that the information has been received (S605), the information processor 205 ascertains that the movable apparatus 110 has moved in/out from the virtual work space 130 by reading the received RFID sensor information (S610). In this process, it is preferable that the information processor 205 ascertains that the sensor recognition reader 100 of the movable apparatus 110 has sequentially read the same kind of recognition sensor informations (e.g. reading first sensor information and then reading the same kind of first sensor information, or reading second sensor information and then reading the same kind of second sensor information), or has sequentially read different kind of recognition sensor informations (e.g. reading first sensor information and then reading a different kind of sensor information, or reading second sensor information and then reading a different kind of first sensor information), by reading the received recognition information. Further, when it is ascertained that the sensor recognition reader 100 has read the second sensor information from the recognizing sensor 105 and then read the same kind of second sensor information, as the ascertained result, the information processor 205 determines that the movable apparatus 110 does not move in the virtual work space 130 and exists at the outside. Further, when it is ascertained that the sensor recognition reader 100 has read the second sensor information from the recognizing sensor 105 and then read a different kind of first sensor information, from the ascertained result, the information processor 205 determines that the movable apparatus 110 has moved in the virtual work space 130 from the outside. Further, when it is ascertained that the sensor recognition reader 100 has read the first sensor information from the recognition sensor 105 and then read the same kind of first sensor information, from the ascertained result, the information processor 205 determines that the movable apparatus 110 does not move out of the virtual work space 130 and moves therein. Further, when it is ascertained that the sensor recognition reader 100 has read the first sensor information from the recognizing sensor 105 and then read a different kind of second sensor information, from the ascertained result, the information processor 205 determines that the movable apparatus 110 has moved outside from the virtual work space 130.

When it is ascertained that the movable apparatus 110 have moved in the virtual work space 130, from the ascertained result (S615), the information processor 205 ascertains one or more RFID code informations (or whether to read RFID code information) which are received from the communication module 255 (S620).

Further, when the RFID code informations (whether to read RFID code information) is ascertained (S625), the information processor 205 ascertains one or more RFID code informations (or whether to read RFID code information) which are received from the communication module 255 (S630), and then creates taking-in ascertainment information including the ascertained RFID code informations and transmits it to the central management server 200, by using the communication network 165 (S635). In this case, it is preferable that the taking-in ascertainment information for the goods loaded on the movable apparatus includes at least one or more of identification information of the movable apparatus (e.g. RFID tag information given to the movable apparatus), pallet identification information (e.g. RFID tag information given to the pallet with the goods thereon), virtual work space information (e.g. ID information of the virtual work space), and one or more RFID code information loaded on the movable apparatus 110.

On the contrary, when the RFID code information (whether to read RFID code information) is not ascertained (S625), the information processor 205 creates moving-in ascertainment information representing that the movable apparatus 110 has moved in the virtual work space 130 and transmits it to the central management server 200, by using the communication network 165 (S640). In this case, it is preferable that the moving-in ascertainment information for the movable apparatus includes at least one or more of identification information of the movable apparatus, pallet identification information, and virtual work space information.

When it is ascertained that the movable apparatus 110 has moved out from the virtual work space 130, from the ascertained result (S645), the information processor 205 ascertains one or more RFID code informations (or whether to read RFID code information) which are received from the communication module 255 (S650).

When the RFID code informations (or whether to read RFID code information) is ascertained (S655), the information processor 205 ascertains one or more EFID code informations (or whether to RFID code information) which are received from the communication module 255 (S660), and then creates taking-out ascertainment information including the ascertained RFID code informations and transmits it to the central management server, by using the communication network (S665). In this case, it is preferable that the taking-out ascertainment information for the goods loaded on the movable apparatus includes at least one of identification information of the movable apparatus, pallet identification information, virtual work space information, and one or more RFID code information loaded on the movable apparatus 110.

On the contrary, when RFID code information (whether to read RFID code information) is not ascertained (S655), the information processor 205 creates moving-out ascertainment information representing that the movable apparatus 110 has moved out from the virtual work space 130 and transmits it to the central management server 200, by using the communication network 165 (S670). In this case, it is preferable that the moving-in ascertainment information for the movable apparatus includes at least one or more of identification information of the movable apparatus, pallet identification information, and virtual work space information.

The preferred implementing examples and embodiments of the present invention, which were described above, were provided for the purpose of exemplifying, the present invention may be changed, modified, and added in various way from the implementing examples and embodiments by those skilled in the art, within the scope and spirit of the present invention, and the change, modification, and addition should be construed as being included in the claims of the present invention. For example, as another implementing example of the present invention, it is possible to ascertain moving-in/moving-out ascertainment information of the movable apparatus 110 (and/or taking-in/taking-out ascertainment information of the goods loaded on the movable apparatus) from the processing module 260 in link with the sensor recognition reader 100 and the RFID reader 250 by providing the processing module 260 of the movable apparatus 110 with the moving-in ascertaining unit 225, moving-out ascertaining unit 230, taking-in ascertaining unit 235, and taking-out ascertaining unit 240 of the information processor 205. In this case, it is possible to transmit the ascertainment information(s) to the central management server 200 in link with the processing module 260, by using the wireless communication network (or wireless local area network). Further, the claims of the present invention fully include all of the modifications and implementing examples, which is included in the scope and spirit of the present invention.

1. A method of managing a virtual space that sets a virtual line dividing a virtual work space region in an actual work space where goods are taken in/out, for taking-in/out of the goods, on the floor of the work space, embeds one or more recognizing sensors at predetermined intervals at both sides of the virtual line, and provides a movable apparatus that moves into/out of the work space with one or more sensor recognition readers that read the recognizing sensors, the method comprising:
consistently storing first sensor information in the recognizing sensors embedded inside the virtual work space from the virtual line and second sensor information in the recognizing sensors embedded in the outside of the virtual work space, in order to recognize whether the movable apparatus passes the virtual line; and
determining that the movable apparatus does not move out from the virtual work space, when the sensor recognition reader reads first sensor information and then reads the same kind of first sensor information, and determining that the movable apparatus has moved out from the virtual work space, when the sensor recognition reader reads first sensor information and then reads a different kind of second sensor information.

2. The method of managing a virtual space according to claim 1, further comprising:
ascertaining whether on or more goods are loaded on the movable apparatus, when determining that the movable apparatus has moved out from the virtual work space in the determining; and
when ascertaining that one or more goods are loaded on the movable apparatus, deciding that the ascertained goods have been taken out from the virtual work space.

3. The method of managing a virtual space according to claim 1, further comprising:
determining that the movable apparatus does not move in the virtual work space, when the sensor recognition reader reads second sensor information and then reads the same kind of sensor information, and
determining that the movable apparatus has moved in the virtual work space, when the sensor recognition reader reads second sensor information and then reads a different kind of first sensor information.

4. The method of managing a virtual space according to claim 3, further comprising:
ascertaining whether one or more goods are loaded on the movable apparatus, when determining that the movable apparatus has moved in the virtual work space in the determining; and
when ascertaining that one or more goods are loaded on the movable apparatus, deciding that the ascertained goods have been taken in the virtual work space.

5. The method of managing a virtual space according to claim 1, wherein when the first sensor information includes odd-numbered information, the second sensor information includes even-numbered information, or
when the first sensor information includes even-numbered information, the second sensor information includes odd-numbered information, or
when the first sensor information includes information outputted at ‘0’ by bit calculation with the information included in the sensor recognition reader, the second sensor information includes ‘1’ or information outputted as ‘1’ by bit calculation with the information included in the sensor recognition reader, or
when the first sensor information includes ‘1’ or information outputted as ‘1’ by bit calculation with the information included in the sensor recognition reader, the second sensor information includes ‘0’ or information outputted as ‘0’ by bit calculation with the information included in the sensor recognition reader, or
when the first sensor information includes ‘TRUE’ or information recognized as ‘TRUE’, the second sensor information includes ‘FALSE’ or information recognized as ‘FALSE’, or
when the first sensor information includes ‘FALSE’ or information recognized as ‘FALSE’, the second information sensor includes ‘TRUE’ or information recognized as ‘TRUE’.

6. A recording medium that is recorded with a program executing the method according to claim 1, and can be read by a computer.

7. A movable apparatus that moves into/out of a space in which a virtual line dividing a virtual work space region in an actual work space where goods are taken in/out, for taking-in/out of the goods, on the floor of the work space, one or more recognizing sensors are embedded at predetermined intervals at both sides of the virtual line, first sensor information is stored in one or more recognizing sensors embedded inside the virtual work space and second sensor information is stored in one or more recognizing sensors embedded outside the virtual work space, the movable apparatus comprising:
a sensor recognition reader that sequentially reads one or more recognition sensor informations from the recognizing sensors;
an RFID reader that reads one or more RFD informations from RFID tags attached the goods; and
a communication module that transmits at least one of the recognition sensor informations, taking-in information of the goods and taking-out information of the goods which are ascertained by reading the recognition sensor information, and the RFID code information, to a server, by using a communication network.

8. The movable apparatus according to claim 7, further comprising: a processing module that determines that the movable apparatus does not move out from the virtual work space, when first sensor information of the recognition sensor informations is read and then the same kind of first sensor information is sequentially read from the recognizing sensors, and determines that the movable apparatus has moved out from the virtual work space, when first sensor information of the recognition sensor informations is read and then a different kind of second sensor information is sequentially read from the recognition sensor.

9. The movable apparatus according to claim 8, wherein the processing module ascertains the one or more RFID code informations and decides that the goods corresponding to the ascertained REID code informations have been taken out from the virtual work space, when it is determined that the movable apparatus has moved out from the virtual work space.

10. The movable apparatus according to claim 8, wherein the processing module determines that the movable apparatus does not move in the virtual work space, when second sensor information of the recognition sensor informations is read and then the same kind of second sensor information is sequentially read from the recognizing sensors, and determines that the movable apparatus has moved in the virtual work space, when second sensor information of the recognition sensor informations is read and then a different kind of first sensor information is sequentially read from the recognizing sensors.

11. The movable apparatus according to claim 10, wherein the processing module ascertains the one or more RFID code informations and decides that the goods corresponding to the ascertained RFID code informations have been taken in the virtual work space, when it is determined that the movable apparatus has moved in the virtual work space.

12. The movable apparatus according to claim 7, wherein the sensor recognition reader includes one or more directional antennas facing the floor of the work space.

13. A system for managing a virtual work space that sets a virtual line dividing a virtual work space region in an actual work space where goods are taken in/out, for taking-in/out of the goods, on the floor of the work space, embeds one or more recognizing sensors at predetermined intervals at both sides of the virtual line, and constantly stores first sensor information in one or more recognizing sensors embedded inside the virtual work space and second sensor information in one or more recognizing sensors embedded outside the virtual work space such that a movable apparatus moving into/out of the work space reads one or more recognition sensor information from the recognizing sensors, the system comprising:
an information receiving unit that sequentially receives one or more recognition sensor informations that are received from the movable apparatus;
a moving-out ascertaining unit that determines that the movable apparatus does not move out from the virtual work space, when first sensor information of the recognition sensor informations is received and then the same kind of first sensor information is sequentially received, and determines that the movable apparatus has moved out from the virtual work space, when first sensor information of the recognition sensor informations is received and then a different kind of second sensor information is sequentially received; and
a moving in ascertaining unit that determines that the movable apparatus has moved in the virtual work space, when second sensor information of the recognition sensor informations is received and the same kind of second sensor information is received, and determines that the movable apparatus has moved in the virtual work space, when second sensor information of the recognition sensor informations is received and then first sensor information is sequentially received.

14. A recording medium that is recorded with a program executing the method according to claim 2, and can be read by a computer.

15. A recording medium that is recorded with a program executing the method according to claim 3, and can be read by a computer.

16. A recording medium that is recorded with a program executing the method according to claim 4, and can be read by a computer.

17. A recording medium that is recorded with a program executing the method according to claim 5, and can be read by a computer.
